(19) United States
(12) Patent Application Publication
(10) Pub. No.: US 2014/0124056 A1
(43) Pub. Date: May 8, 2014

(54) Wrap-around gas bottle valve body protective device

(71) Applicant: Frederick W. Zeyfang, Erie, PA (US)

(72) Inventor: Frederick W. Zeyfang, Erie, PA (US)

(21) Appl. No.: 13/694,164

(22) Filed: Nov. 2, 2012

(51) Int. Cl. F16K 35/00; F17C 13/04

(52) U.S. Cl. CPC F16K 35/00; F17C 13/04
USPC 137/382

(57) ABSTRACT

A protective device for a gas cylinder valve body is provided comprising a multi-sided body capable of being positioned about the sides of a four-sided gas cylinder valve body, the body comprised of at least two segments hinged with respect to each other, and which when the segments are pivoted toward each other form a four-sided body corresponding in configuration to a corresponding portion of the four sides of the valve body. At least one of the segments has at least two sides oriented at a right angle and fixed to each other. One of the sides of one of the segments has at least one projection on an interior surface thereof configured to engage at least a portion of an opposing surface of the valve body. Free ends of adjacent segments are capable of being connected to each other to maintain the device in position about the valve body, and the device includes at least one tear strip whereby the protective device may be removed by tearing the tear strip.

### BACKGROUND OF THE PRESENT INVENTION

The present invention is directed to a protective device for use in connection with gas bottle post valves.

Gas bottles have a variety of end uses. Such end uses range from various industrial applications, where a specified gas is required (ranging from inert gases, such as nitrogen, to oxygen gas), to medical uses where oxygen is to be administered to a patient in need of oxygen. Such bottles have a tubular valve body extending from an end of the gas bottle for engagement with a gas delivery tube or pipe.

A successful protective product for use with, for instance, the CGA 870 medical oxygen post (four sided elongated valve body) should satisfy the following performance criteria: (a) prevent dust and debris from entering the oxygen supply port on the side of the valve body, (b) be easy to install with a quick sliding motion, (c) remain firmly in place on the gas valve body during handling, transportation, and storage before use by the gas user, and not prematurely rupture or become dislodged, (d) be easy for the end user to remove who is typically aged and/or infirmed, (e) serve to easily identify a full cylinder from an empty cylinder at a quick glance and at a distance of up to 50 feet, and (f) provide “use evidence” (i.e., evidence that the compressed gas cylinder is still full, and has not previously been used). There may be circumstances where it is desirable for the protective device to be translucent so that the valve seat sealing surface condition and valve pin index identifier can be inspected while the protective device is installed on the valve body, but that is not an important factor.

Such “use evidence” is particularly important because in emergency medical situations it is important for emergency personnel to be able to quickly identify which cylinder contains oxygen for use by a patient. “Use evidence” is also important to re-fillers of such compressed gas re-fillers, because full cylinders are frequently returned for credit when a full cylinder cannot be identified by content. This increases the re-filler's costs and affects the oxygen user's perception of value and quality provided by the re-filler.

It is also important that it be easy for the end user to remove the protective device from the valve body. Many medical oxygen users are aged, and possibly also infirmed, individuals requiring home-based oxygen therapy. Any difficulty in removing the protective device could interfere with delivery of oxygen, or require assistance from another person if the protective device is not easily removed. An additional benefit sought for the protective device is the ability to physically protect the valve seat (the area between the bottom end of the protective device and the top of the compressed valve cylinder). Scratches and damage to the valve seat and post valve surface result in leak paths for oxygen to escape, which can result in explosion and/or fire.

The protective device must also address the needs of all who use or benefit from the protective device. Such parties include the compressed gas producers (who fill the gas bottles and initially install the protective device), the compressed gas distributors who receive the compressed gas bottles having the protective device, and the ultimate end users (home-based patients, hospitals, medical care personnel, etc.). Each level of distribution sometimes requires different attributes of the protective device. For instance, the compressed gas producer requires a protective device which is easy to install, is protective in nature, and locks into place. The distributor requires the protective device to be physically stable as installed, and not subject to being displaced from the valve body during storage or transportation. The ultimate end users require the protective device to be physically stable as installed to provide “evidence of use” indication, and easy to remove. For example, some prior art devices with wrap-around locking means require the locking strap to be cut to remove the device.

Ease of installation has always been a problem with prior art valve body protective devices. Shrink wrap devices require the device to be wet when applied, and also are required to dry or be dried by application of heat to cause the required shrinkage. Those with wrap-around locking straps are cumbersome to physically handle. Those which are four-sided band-like devices, as a result of their short length, may require finger pressure along the top of the device while at the same time running the fingers against the side of the valve body. Due to the thin walls of the device, it is difficult to apply much downward pressure against the device with the installer's fingers. Also, due to the small contact area for the installer's fingers, the fingers will always rub against the side of the valve body during installation. They may also require a special tool to install the device, or be heated to soften the device prior to installation.

Additionally, CGA 870 valve bodies exhibit dimensional variations of up to 0.030 inch across each axis, so that bands such as described in U.S. Pat. No. 3,125,242 require excessive installation forces as the band must be able to be caused to stretch to the upper dimensional tolerances of the valve body while still maintaining security at the lower dimensional tolerances of the valve body. A variation of this device is described at U.S. D612,012.

The protective device most predominately used for the past 50 years is the elastic band protector described by U.S. Pat. No. 3,125,242 which has multiple shortcomings. Another widely used protective product used in the medical gas industry is the cellulose shrink wrap. The other products offered to the medical gas industry have deficiencies that limit their market acceptance. The “cellulose shrink wrap” product is basically an elongated wet cellulosic device that slips over the valve body, and is caused to shrink about the valve body upon exposure to heat, or shrinks as it dries. The product has the disadvantage of requiring installers of the device to get their hands wet to install the device. The device additionally requires substantial time to dry and shrink at which time the cylinder and valve must be stationary. While this product provides a barrier to dust and dirt, it is not durable (it is subject to disintegration as the shrink wrap material is fragile) and provides no protection upon being struck. The cellulosic device product also provides no inspection visibility of the valve seat and pin index condition as it is opaque, and it is often difficult for the end user to remove the shrunken device prior to use. Further disadvantages include the shrink wrap prematurely dislodging if the cylinder is lifted by the valve body (as commonly occurs in the industry), and the shrink wrap dislodging when exposed to moisture (as commonly occurs when shipped in open truck beds exposed to weather, rain and snow. The main advantage of this product is its low cost.

Several prior art gas valve protective products exist, including cellulose bands and shrink wrap, and those described by U.S. Pat. No. 5,397,012, U.S. Pat. No. 3,125,242, and U.S. Pat. No. 6,003,714, as well as U.S. D612,012 and U.S. D612,013. Each of these products provide certain benefits, but none provide all of the desired benefits. The device of U.S. Pat. No. 5,397,012 is essentially the same as that of U.S. Pat. No. 3,125,242 with the exception that the device is cut, opened, and has a ratchet locking mechanism. The device of U.S. Pat. No. 5,397,012 appears to have been developed in an attempt to improve on the installation shortcomings of the device of U.S. Pat. No. 3,125,242 which requires tools and/or other installation aids and requires substantial downward force for installation. However, in actual practice the device of U.S. Pat. No. 5,397,012 becomes very cumbersome to install by requiring two hands to pre-fold each corner of the device before assembly. The device additionally requires special attention to position on the valve post, while finding, orienting, positioning, and threading the ratchet tab into the ratchet locking mechanism at the back of the valve requires further focused attention by the installer. Because of the device's requirement to wrap around the valve post, the ratchet lock and tab become angled at an unnatural orientation requiring further installation care.

The product described by U.S. Pat. No. 5,397,012 is not easy to place on the valve body and lock in place due to the small size of the locking strap. The locking strap, when locked into place, must also be cut or broken for the device to be removed from the valve body. The product is also so small that it is difficult to determine from any distance the status (filled, unfilled) of the gas cylinder upon which it is placed. The thin strap can easily rupture and prematurely fall off if bumped in handling and transit. This device additionally requires two hands and substantial care and time to install.

The device described by U.S. Pat. No. 3,125,242 consists of a flexible band that is snug-fit onto the valve body. As it is such a snug-fit on the valve body, the band must either be softened in hot water to permit the band to be stretched over the valve body, or a special tool must be used to assist in sliding the band over and onto the valve body. A representative tool 16 is described at FIG. 1 of the U.S. Pat. No. 3,125,242. As described by the patent at column 3, lines 35-73, the band is placed around the circumference of the tool body, the tool body placed into engagement with the valve body, and the band pushed off the tool body into snug engagement with the valve body. This protective product is thus not easy to install upon the valve body. A similar device is described in U.S. D612,012.

The protective device described by U.S. Pat. No. 6,003,714 is even more cumbersome than the protective device of U.S. Pat. No. 3,125,242. The device of this patent must be wrapped around the valve body in covering position to the gas orifice, with one free end being locked into a locking mechanism of the other free end to maintain the device in place. The fact that this protective device is able to be wrapped around the valve body (instead of being pulled over) attempts to solve the main problem with the protective device of U.S. Pat. No. 3,125,242, which is ease of installation. However, this solution is only partially successful, as the fact that one free end must be placed into the locking mechanism at the other end and pulled tight for locking purposes requires some dexterity and extra effort. This is a significant problem when these protective devices are placed on large numbers of compressed gas cylinder valve bodys in an assembly line type of environment due to the manual labor involved. This type of protective device is also difficult to secure tightly around the valve body and is prone to becoming accidentally dislodged during normal handling.

Moss Plastic Parts, Ltd. sells a band-like gas cylinder valve “Type 3” protector which suffers from some of the same disadvantages as other prior art valve body protectors, such as being band-like, and lacking the requisite flange(s). The Moss “Type 3” protector has corner configurations which permit the device to expand as needed, and as a result has a dimensionally unstable fit which results in an unreliable assembly onto the valve body, and only has a single tear line along the corner of the device, which, together with the band-like design of the product, makes the product difficult to remove from engagement with the valve body.

Thus, for over 50 years, despite the problems with prior art valve body protective devices, no new product has been introduced prior to the inventor's patented product of U.S. Pat. Nos. 7,681,587 and 8,141,578 (a similar protective device was subsequently introduced into the marketplace and described in U.S. D612,013) and the present invention which satisfactorily meets all of the criteria desired to be met for the protective product to be considered totally successful. Users want a single-handed quick installation, easy low force, reliable gas valve body protector.

A need accordingly exists for means by which a gas bottle may be modified to clarify whether gas has been delivered by the bottle, or whether the bottle is unused, and which does not suffer from any of the disadvantages suffered by conventional devices.

### OBJECTS AND SUMMARY OF THE INVENTION

It is accordingly an object of the present invention to provide a protective device for use with compressed gas bottle post valve bodies.

It is further an object of the present invention to provide a protective device that will serve to seal a gas port in a post valve body of a gas bottle.

It is further an object of the present invention to provide a protective device that can be easily placed in locking engagement with a post valve body of a gas bottle.

It is further an object of the present invention to provide a protective device that may be easily engaged and easy to remove, while remaining in secure protective engagement with the valve body during use.

A gas cylinder valve body protective device is accordingly provided comprising a multi-sided body capable of being positioned about at least a portion of the longitudinal extent of the sides of a four-sided gas cylinder valve, the gas cylinder valve body having a gas port and pin index holes, the multi-sided body comprised of at least two segments hinged with respect to each other with two of said segments having a free end, and which when the segments are pivoted toward each other, form a multi- or four-sided body, at least one of the segments having at least two sides oriented at a right angle and fixed in relation to each other, one of the segments having at least one projection extending from an interior surface thereof and configured to engage at least a portion of an opposing surface of the valve body whereby the protective device is prevented from being easily removed from engagement with the valve body, said free ends of said two segments being capable of being connected to each other to maintain the multi-sided body fixed about at least a portion of the longitudinal extent of said valve body, the device including at least one tear strip whereby the protective device may be removed by tearing the tear strip so as to permit disengagement and removal of the protective device from encompassing relationship with the valve body.

### BRIEF DESCRIPTION OF THE DRAWINGS

FIGS. 1-6 depict an embodiment of the protective device of the present invention being installed on a medical gas cylinder valve body.

FIGS. 7-8 are perspective views of another embodiment of the protective device of the present invention.

FIGS. 9-13 depict the embodiment of the protective device of FIGS. 7-8 being installed on a medical gas cylinder valve body.

FIGS. 14-15 are perspective view of another embodiment of the protective device of the present invention.

FIGS. 16-20 depict the protective device of FIGS. 14-15 being installed on a medical gas cylinder valve body.

FIGS. 21-26 depict another embodiment of the protective device of the present invention being installed on a medical gas cylinder valve body.

FIGS. 27-28 are views in perspective of another embodiment of the protective device of the present invention.

FIGS. 29-33 depict the embodiment of FIGS. 27-28 being installed on a medical gas cylinder valve body.

FIGS. 34-39 depict another embodiment of the protective device of the present invention being installed on a medical gas cylinder valve body.

FIGS. 40-43 depict another embodiment of the protective device of the present invention being installed on a medical gas cylinder valve body.

### DETAILED DESCRIPTION OF THE INVENTION

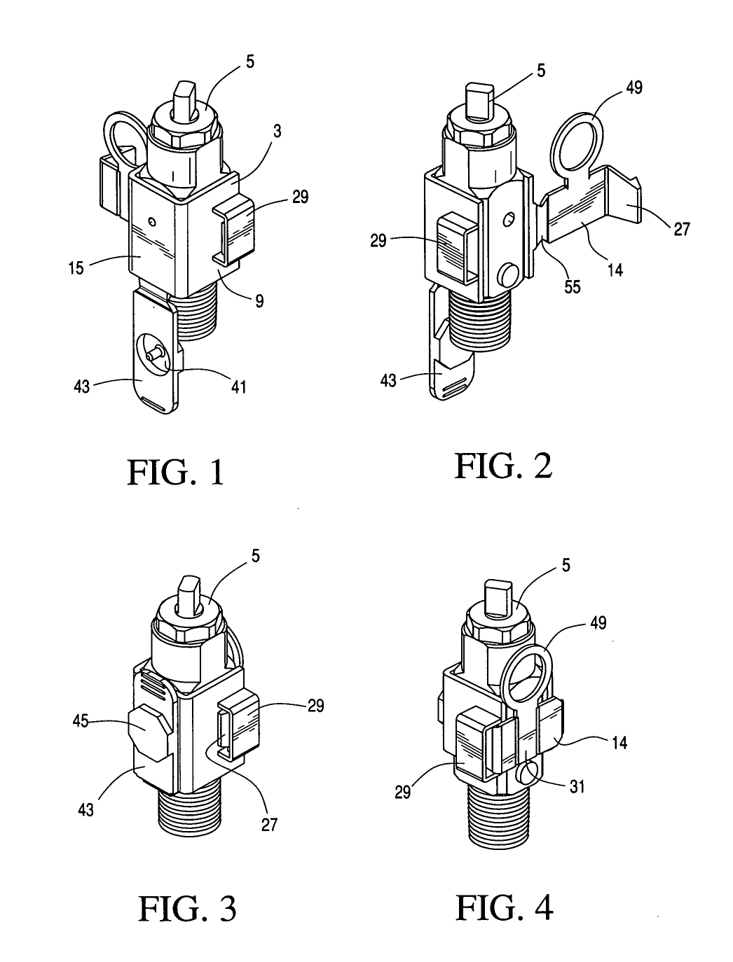

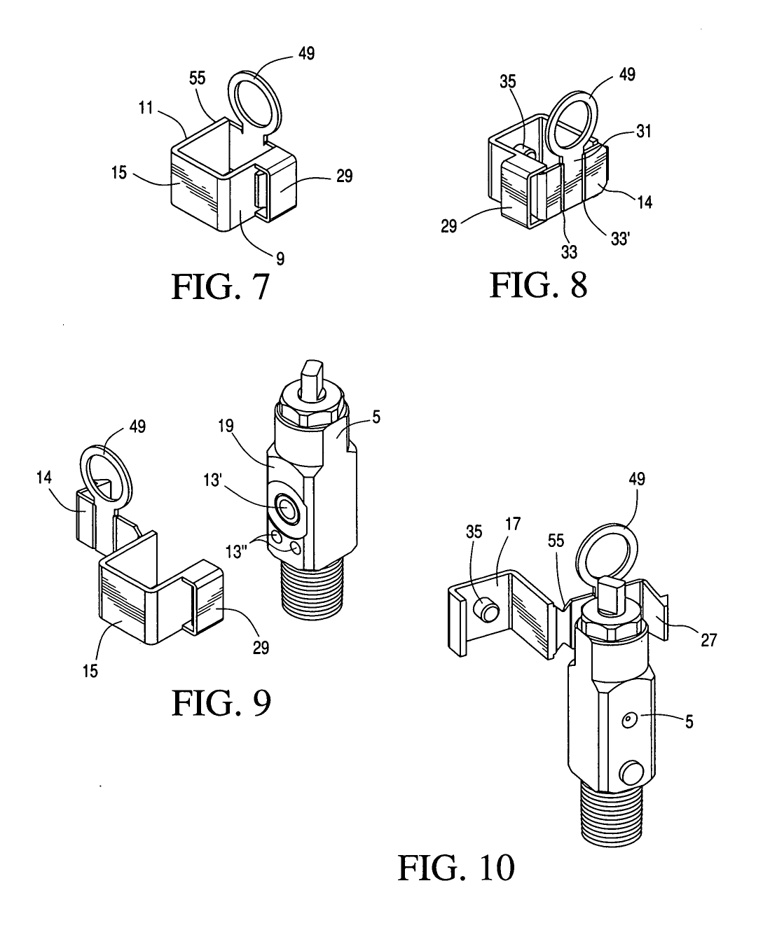

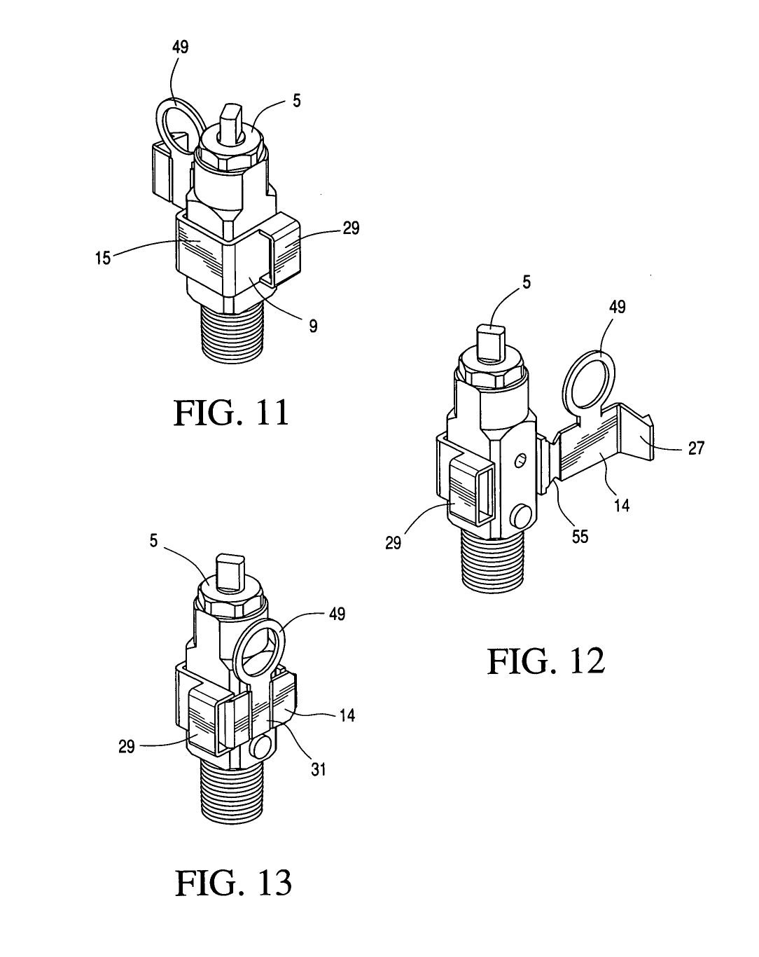

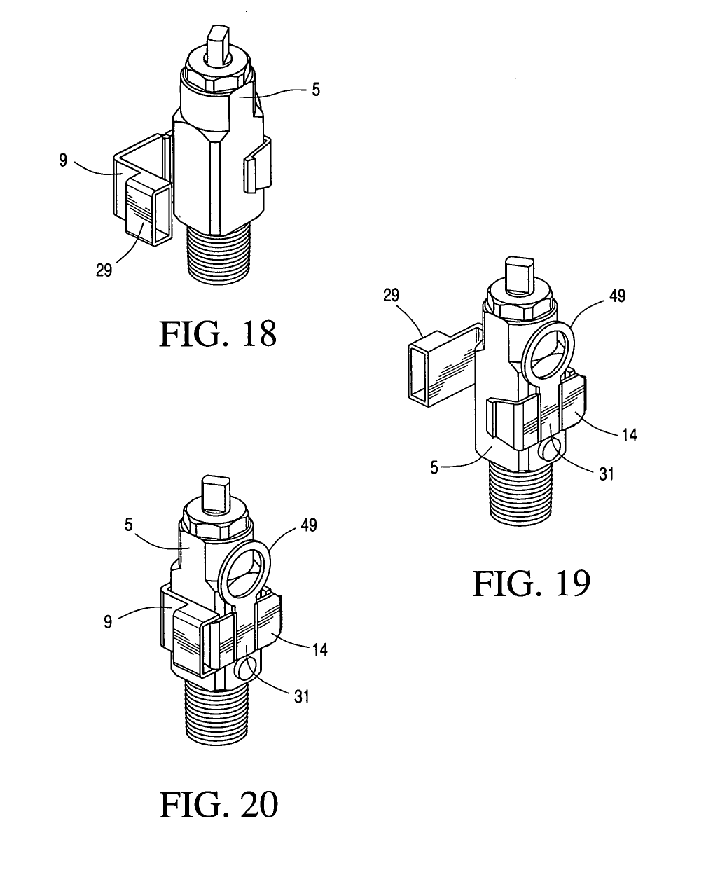

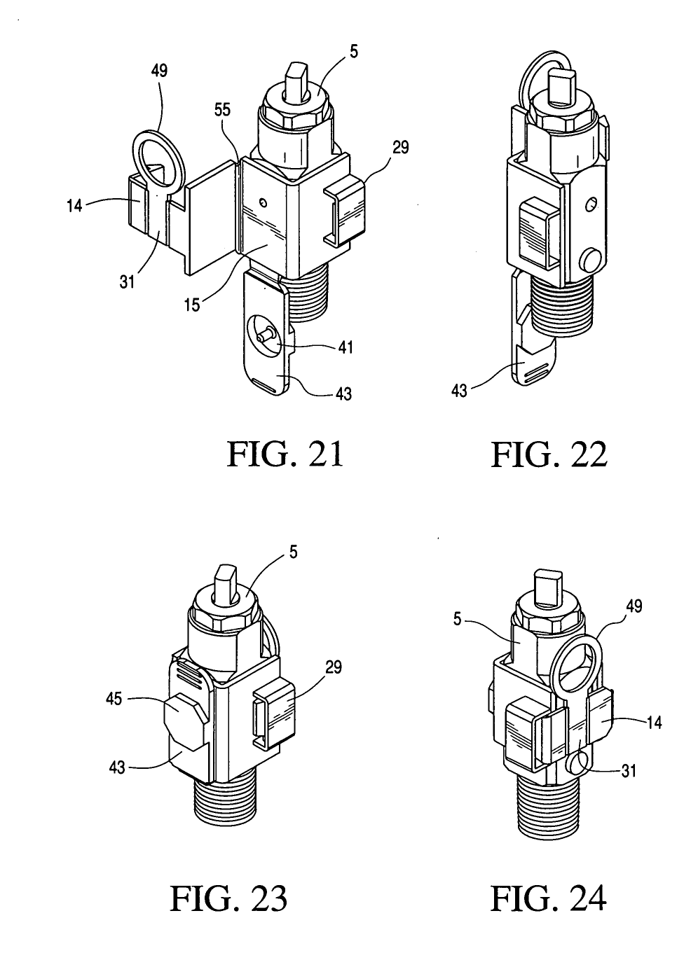

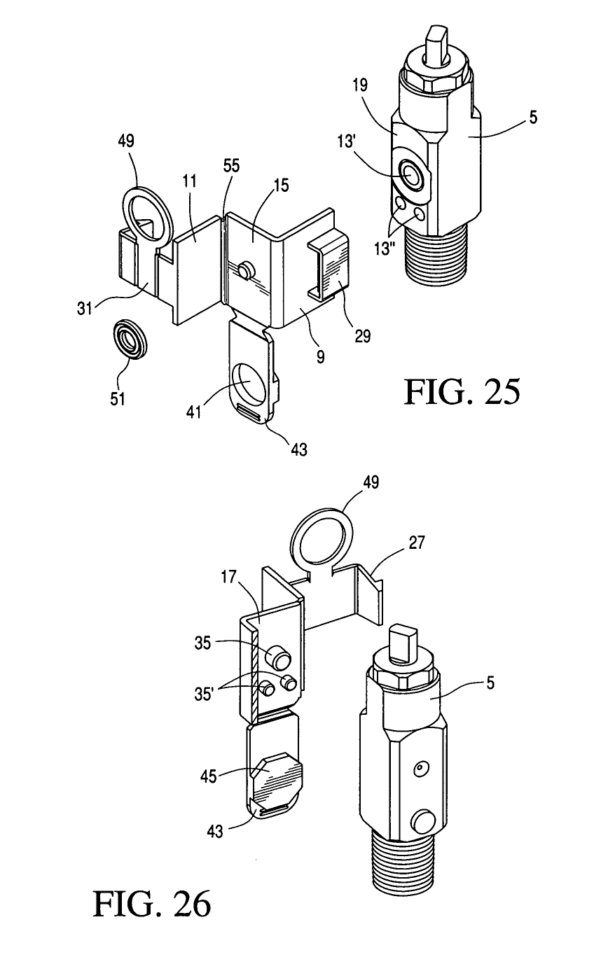

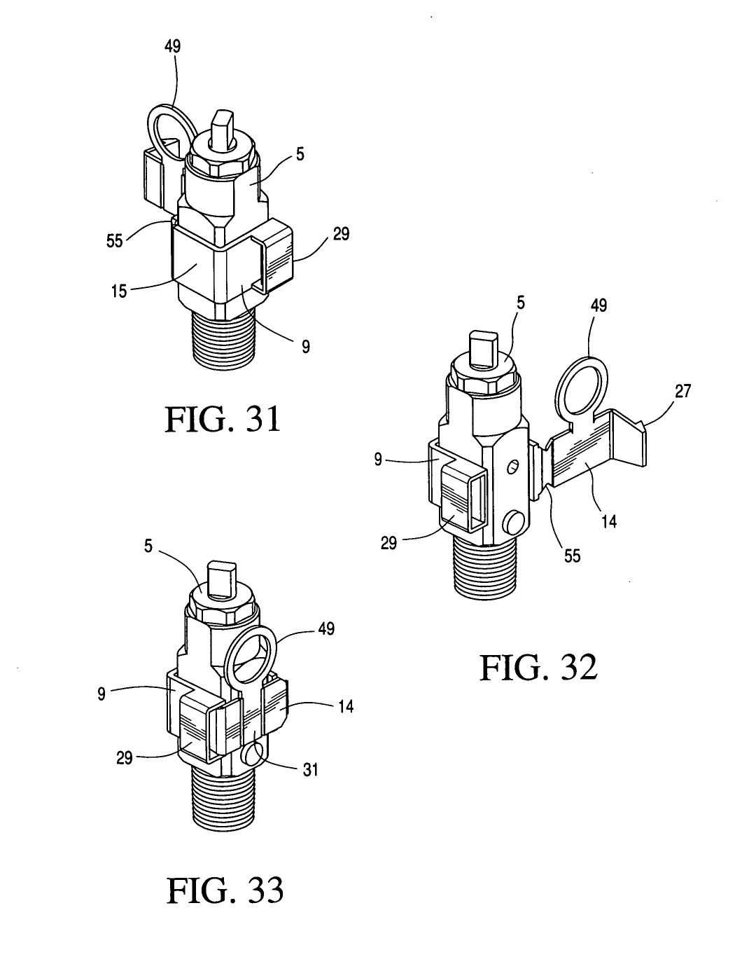

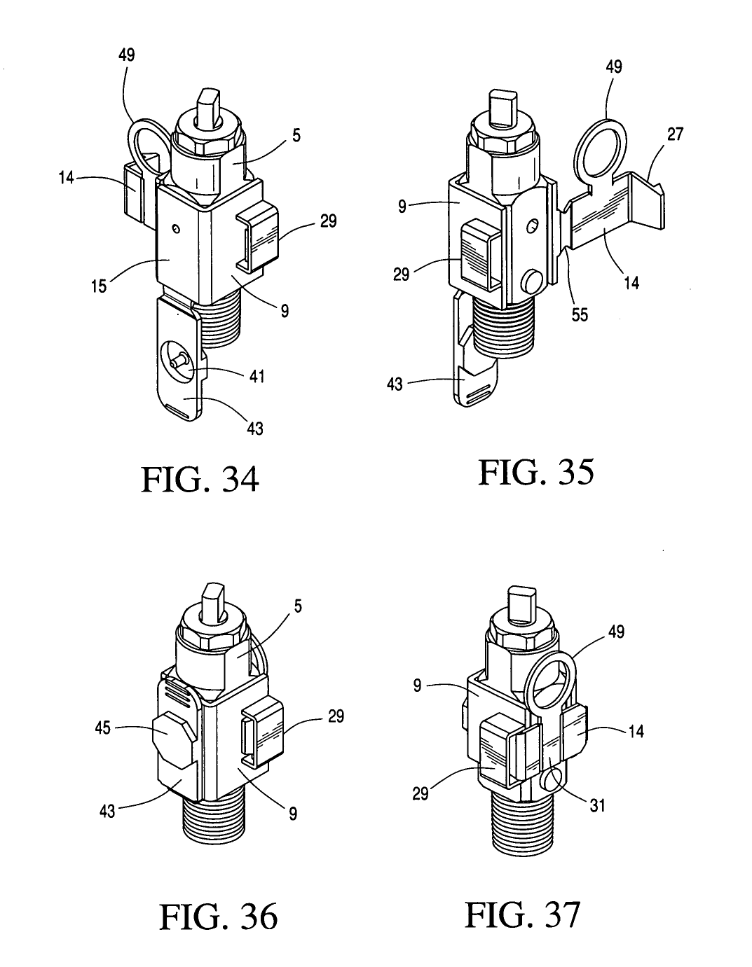

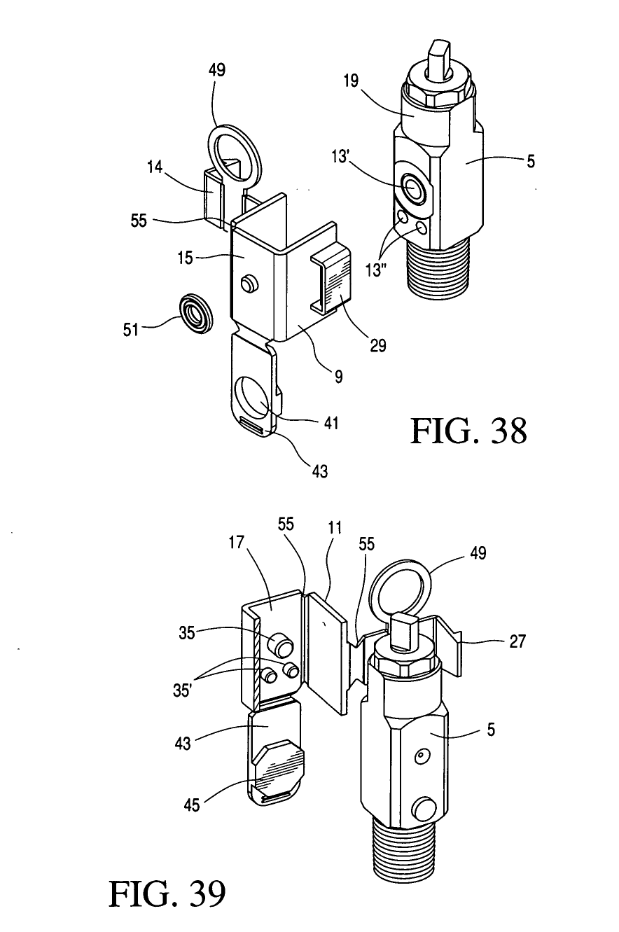

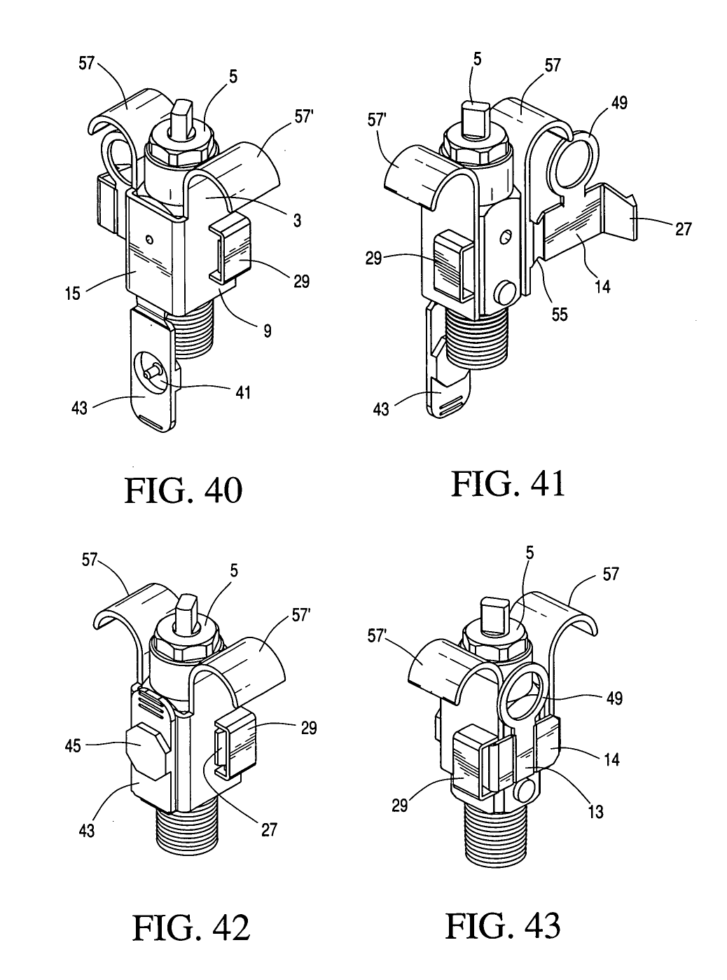

The invention will be described in connection with the FIGS. 1-43.

As shown in the Figures, the present invention comprises a protective device for use in connection with a valve body 5 for gas bottles. The protective device is comprised of a four-sided body 3 of such length as to extend along at least a portion of the length or longitudinal extent of the valve body 5.

The device of the present invention comprises at least two segments hinged with respect to each other, one of the segments comprising at least two sides, with the total number of sides in the segments equaling four in number. At least one of the segments comprises at least two sides fixed to each other at a right angle. In the Figures, hinge 55 is noted as forming the junction between hinged segments of the protective device.

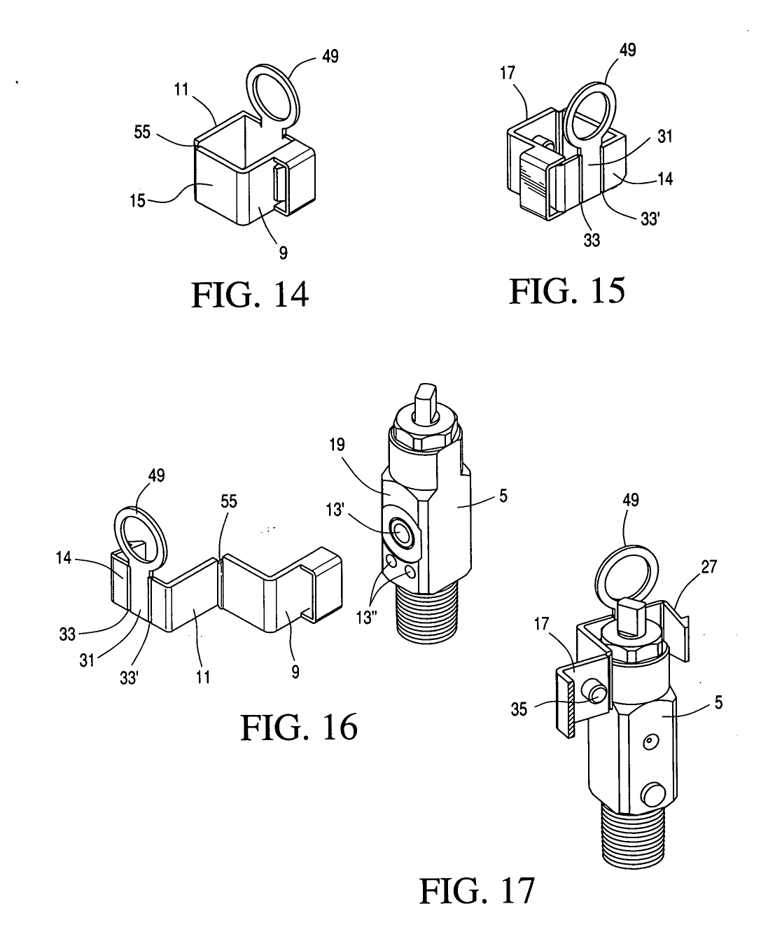

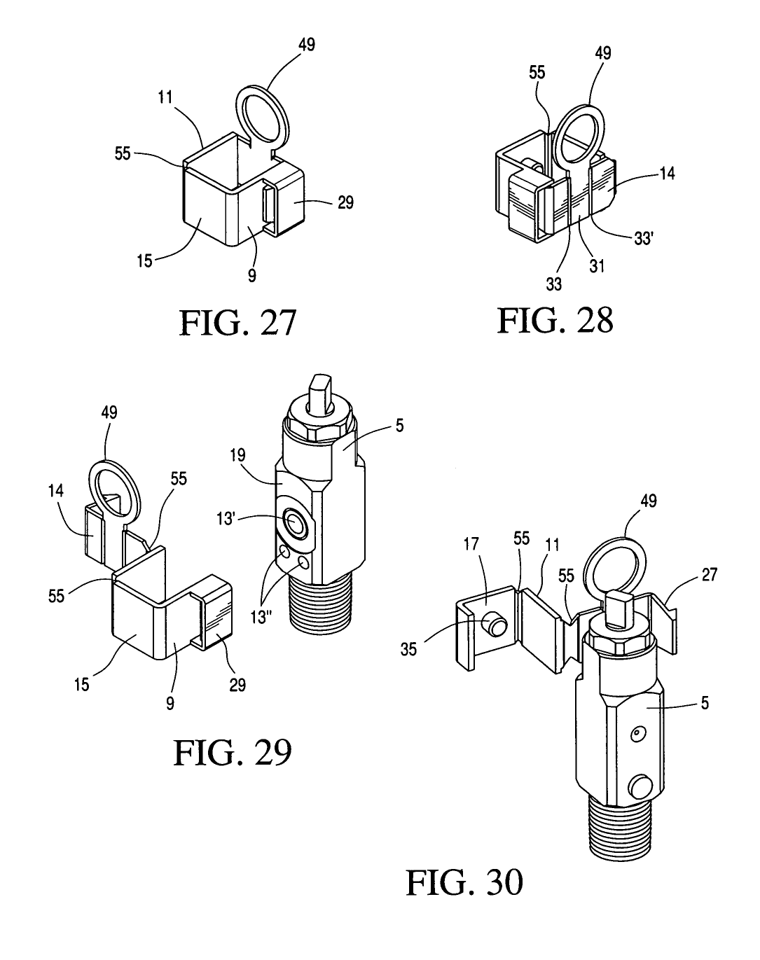

By way of example, the device of the present invention may comprise two segments hinged with respect to each other, with one segment having one side, and the other segment having three fixed sides, with the sides being fixed with respect to each other at right angles (FIGS. 1-13 and 40-43). Alternatively, the device of the present invention may comprise three segments each hinged with respect to each other, with two segments having one side each, and the remaining segment having two sides fixed at a right angle to each other (FIGS. 27-39). By way of further embodiment, the device may comprise two segments hinged with respect to each other, with each segment having two sides fixed at a right angle to each other (FIGS. 14-26).

The cross-sectional configuration of the protective device should be such that the device, when installed on the gas valve body, snugly engages the valve body to enhance the engagement of the protective device with the valve body in the manner discussed below. The four-sided body has sufficient structural integrity as to result in the desired snug fit which pushed onto and wrapped around the valve body.

The protective device, when installed, is open-ended at each end to enable the device to be placed onto the valve body from the side and subsequently locked into engagement therewith.

Finger grip members 57, 57′ may optionally be present which extend from the top or uppermost extent of opposing sides 9, 11 of the protective device. The finger grip members 57, 57′ are configured to be easily engaged by the user's fingers to enable the device (and hence the attached gas cylinder via the valve body 5) to be lifted and transported by the user. The upwardly-extending finger grip members are preferably arcuate in configuration so as to comfortably being capable of being gripped by the finger of a user or transporter of the device. However, the gripping surface of the finger-grip members may be any suitable configuration capable of being gripped. The finger grip members need not be present, but when present, facilitate transport of the attached compressed gas cylinder.

The interior surface 17 of side 15 includes at least one projection/lug (and optionally multiple projections/lugs) which is configured to fit in an opening 13′, 13″ in an adjacent side 19 of the valve body 5. The engagement of the rear side 15 in an adjacent side of the gas valve provides stability for the gas cylinder if lifted by an upward force applied to the protective device if grabbed by fingers, while retaining the protective device in place on the valve body. When opposing side 19 of the valve body is so engaged, the protective device is prevented from being removed from the valve body upon being placed thereon due to engagement of at least one of said projections 35, 35′ with the openings 13′, 13″ in surface 19 of the gas valve body. The locking projection 35, 35′ may be of any suitable cross-sectional configuration which is suitably configured to engage with an opposing opening(s) in the valve body. The projections may engage one or more of the gas port 13′ or pin index holes 13″. Three projections 35, 35′ may be provided which engage a portion of valve body surface 19.

The protective device is maintained about the valve body by locking means 23 on a side segment 14 extending between the adjacent sides 9, 11 of the multi-sided body. One of the adjacent sides has extending therefrom a locking strip 27 capable of being lockingly engaged with the other of the adjacent sides 9 to maintain the body in protective relationship with the valve body.

An exemplary embodiment for the locking means consists of a locking tab 27 at a free end of one of the sides which is lockingly inserted into a locking cavity 29 at a free end of an adjacent side. An alternative embodiment for the locking means includes the use of ratchet means on the locking strip which lockingly engages a locking cavity. The particular locking mechanism used for the locking tab is not critical to practice of the claimed invention, and one skilled in the art can readily select an appropriate mechanism. The locking means need only be able to serve as a connection between the free ends of adjacent sides 9, 11 and to maintain the body in protective relationship to the valve body.

The protective device also includes a mechanism to enable the protective device to be easily removed from locking engagement with the valve body. Desirably, a tear strip 31 (FIGS. 4, 8, 15, 28) is provided the tearing of which enables the protective device to be removed from the valve body. The protective body may thus be removed by tearing the tear strip so as to permit disengagement and removal of the protective device from the valve body.

The tear strip may be defined laterally by opposing tear lines 33, 33′ formed in a side of the protective device, or less desirably, by lines of perforations. The tear lines 33, 33′ preferably extend along the entire longitudinal extent of the protective device, but are not required to do so. The tear lines need only extend along a portion of a side of the protective device to an extent sufficient to permit disengagement of the device from the valve body. The opposing tear lines are preferably parallel, and between which form the requisite tear strip.

In order to enhance the ease by which the tear strip may be torn and removed, a grip member is preferably provided which is attached to a portion of the tear strip to facilitate tearing of the tear strip. The configuration of the grip member is not critical. The grip member may extend either upwardly or downwardly along the longitudinal axis of the protective body, or extend laterally outwardly from the body.

The protective device of the present invention may provide means to carry/store a washer seal 51 (FIGS. 1, 21, 34, 40) for use when connecting the gas bottle, in particular a washer housing.

The Figures depict an attached washer seal housing hingedly connected to the body 3 on tab 43 attached to a side of the body, with the washer seal housing 45 including a recessed cavity 41 configured to store a washer seal suitable for use with a medical gas cylinder gas valve. The tab may be locked upwardly into place against the body of the protective device to maintain the washer seal in place.

The housing 45 may alternatively be integrally molded into one of the walls of the protective device, with the walls of the housing extending a short distance outwardly from the protective device a distance sufficient to account for the thickness of the washer seal. The central hole of the washer seal may be engaged with a projection extending inwardly from a wall of the housing to permit storage of the washer within the housing.

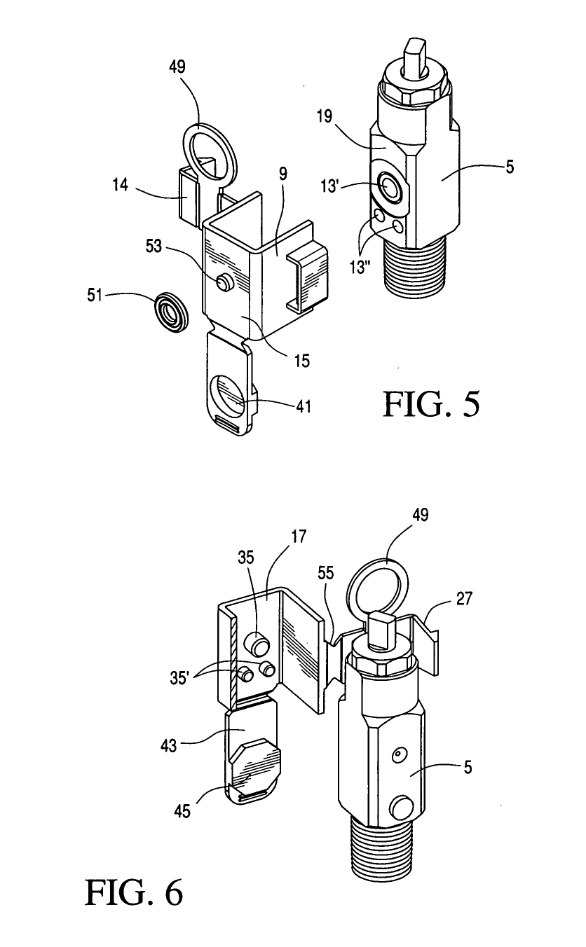

In the depicted embodiment of Figures, a housing 45 for a washer seal is hingedly attached to rear wall 15, having compartment 41 for the washer seal. Ring member 49 is attached to the locking strip and connected to a tear strip. FIG. 6 depicts three projections 35, 35′ configured to engage a corresponding portion of the opposing surface 19 of the gas cylinder valve body having gas port 13′ and index pin holes 13″ (FIG. 5). In FIGS. 6, 10, 17, 26, 30, and 39 a portion of one of the opposing walls is removed to permit viewing of the projections 35, 35″.

In order to install the protective device of the present invention on a gas cylinder valve body, the device is pushed against rear surface 19 of the valve body and the hinged segments wrapped around the valve body in an open configuration (i.e., in an unlocked state). Upon being pushed onto and wrapped around the valve body, at least one projection on surface 17 of the protective device engages a corresponding portion of the valve body (such as the gas port or index pin holes). Upon such engagement, respective sides are placed around the valve body, and the free ends of adjacent sides locked to each other. In order to be removed, the grip member attached to the tear strip is torn along the tear lines, and the protective device removed from protective engagement with the valve body. The manner of installation of the protective device on a valve body is well shown in the Figures.

The protective device may be formed of any suitable material which enables the protective sleeve to function in the manner discussed above. The protective device is preferably comprised of a plastic resin material suitable for molding a unitary molded body (such as by injection molding), and once formed, is sufficiently flexible to be placed over the valve body and into engagement therewith, and sufficiently inflexible to remain engaged therewith absent removal of the tear strip. The protective device may be comprised of a variety of plastic resin materials, such as low density polyethylene or filled flexible polyvinyl chloride. It is may be desirable in some instances for the body to be prepared from a plastic resin material which, once molded, is not entirely opaque, but permits viewing of the exterior of the gas valve body. The selection of such materials and the molding method by which the device may be formed are well known to those of ordinary skill in the art.

What is claimed is:

1. A gas cylinder valve body protective device, said device comprising a multi-sided body capable of being positioned about at least a portion of the sides of a four-sided gas cylinder valve, the gas cylinder valve body having a gas port and pin index holes, the multi-sided body comprised of at least two segments hinged with respect to each other with two of said segments having a free end, and which when the at least two segments are pivoted toward each other, form a four-sided body, at least one of the segments having at least two sides oriented at a right angle and fixed to each other, one of the segments having at least one projection extending from an interior surface thereof and configured to engage at least a portion of an opposing surface of the valve body whereby the protective device is prevented from being easily removed from engagement with the valve body, said free ends of said segments being capable of being connected to each other to maintain the multi-sided body wrapped in place about at least a portion of the longitudinal extent of the valve body, the device including at least one tear strip whereby the protective device may be removed by tearing the tear strip so as to permit disengagement and removal of the protective device from the valve body.

2. The protective device of claim 1, wherein said body comprises two segments each having two side portions connected at a right angle to each other.

3. The protective device of claim 1, wherein said body comprises one segment having three side portions, with each side portion fixedly connected at a right angle to an adjacent side portion.

4. The protective device of claim 1, wherein said body comprises three segments, one of said segments having two sides, with each said side being fixedly connected to an adjacent side at a right angle with respect to each other.

5. The protective device of claim 1, comprising multiple projections each configured to engage a portion of an opposing side of said valve body upon placement of said device about said valve body.

6. The protective device of claim 1, wherein said tear lines extend along the entire longitudinal extent of said protective device.

7. The protective device of claim 1, comprised of a moldable plastic resin material.

8. The protective device of claim 1, wherein said at least one projection is configured to engage a hole in said opposing surface of said valve body.

9. The protective device of claim 8, including one projection which is configured to engage a gas port in said opposing surface of said valve body, and at least one projection which is configured to engage with at least one pin index hole in said opposing surface of said valve body.

10. The protective device of claim 1, further including a housing for storage of a washer seal.

11. The protective device of claim 10, wherein said housing for storage of a washer seal comprises a hinged tab extending from an exterior of one of said sides of said body.

12. The protective device of claim 1, further including a grip member attached to said tear strip.

13. The protective device of claim 1, wherein further comprising finger grip members extending from the top or uppermost extent of opposing sides of said device, said finger grip members configured to be engaged by a user's fingers to permit said device and associated gas cylinder to be lifted.
